(19) United States
(12) Patent Application Publication
(10) Pub. No.: US 2026/0129305 A1
(43) Pub. Date: May 7, 2026

(54) METHODS AND SYSTEMS FOR VIDEO ACQUISITION

(71) Applicant: ZHEJIANG DAHUA TECHNOLOGY CO., LTD., Hangzhou (CN)

(72) Inventors: Lei LIU, Hangzhou (CN); Jianmiao WANG, Hangzhou (CN); Feiyue ZHU, Hangzhou (CN); Guo CHEN, Hangzhou (CN)

(73) Assignee: ZHEJIANG DAHUA TECHNOLOGY CO., LTD., Hangzhou (CN)

(21) Appl. No.: 19/435,869

(22) Filed: Dec. 30, 2025

Related U.S. Application Data
(63) Continuation of application No. PCT/CN2024/091548, filed on May 7, 2024.

(30) Foreign Application Priority Data
Jul. 20, 2023 (CN) 202310897660.3

(51) Int. Cl. H04N 23/73; H04N 23/11; H04N 23/71

(52) U.S. Cl. CPC H04N 23/73; H04N 23/11; H04N 23/71

(57) ABSTRACT

Some embodiments of the present disclosure provide a method for video acquisition. The method may be implemented by a computing device including at least one processor and a storage device, and the method may include: obtaining a first exposure parameter corresponding to a first image frame acquired by a video acquisition device; obtaining a second exposure parameter used by the video acquisition device to acquire a second image frame, wherein the second exposure parameter is smaller than the first exposure parameter; adjusting an exposure parameter of the video acquisition device from the second exposure parameter to a target exposure parameter by adjusting an exposure parameter lower limit of the video acquisition device, wherein the target exposure parameter matches the first exposure parameter; and causing, based on the target exposure parameter, the video acquisition device to acquire a target image frame.

### CROSS-REFERENCE TO RELATED APPLICATIONS

This application is a Continuation of International Application No. PCT/CN2024/091548, filed on May 7, 2024, which claims priority of Chinese Patent Application No. 202310897660.3 filed on Jul. 20, 2023, the entire contents of each of which are hereby incorporated by reference.

### TECHNICAL FIELD

The present disclosure relates to the field of video surveillance, and in particular, to methods and systems for video acquisition.

### BACKGROUND

With the development of video acquisition devices, more and more monitoring functions have been developed. A video acquisition device may detect an intruding object in a monitoring region and control a flashlight to flash to alert against the intruding object. However, the flashing of the flashlight may also interfere with an image acquisition process of the video acquisition device. A current solution for eliminating the interference of the flashing of the flashlight may be to shorten an exposure time and increase an exposure interval between two adjacent image frames of the video acquisition device, allowing the flashlight to flash during the exposure interval to prevent the video acquisition device from capturing the flashing of the flashlight during exposure. However, shortening the exposure time may result in a subsequent image frame being darker than previous image frames acquired before flashing of the flashlight. Even though conventional methods for exposure recovery may increase the brightness gain of the current image or adjust the exposure time of the video acquisition device, it is difficult to avoid reducing the quality of the subsequent image frame.

Therefore, it is desirable to provide a method and a system for video acquisition to ensure image quality while achieving exposure recovery and improving video acquisition effectiveness.

### SUMMARY

One embodiment of the present disclosure provides a method for video acquisition. The method may be implemented by a computing device including at least one processor and a storage device, and the method may include: obtaining a first exposure parameter of a video acquisition device when the video acquisition device acquires a first image frame; obtaining a second exposure parameter used by the video acquisition device to acquire a second image frame, wherein the second exposure parameter is smaller than the first exposure parameter; adjusting an exposure parameter of the video acquisition device from the second exposure parameter to a target exposure parameter by adjusting an exposure parameter lower limit of the video acquisition device, wherein the target exposure parameter matches the first exposure parameter; and causing, based on the target exposure parameter, the video acquisition device to acquire a target image frame.

In some embodiments, the adjusting an exposure parameter of the video acquisition device from the second exposure parameter to a target exposure parameter by adjusting an exposure parameter lower limit of the video acquisition device may include: obtaining a step size for adjusting the exposure parameter lower limit of the video acquisition device, and adjusting the exposure parameter lower limit based on the step size.

In some embodiments, the obtaining the step size for adjusting the exposure parameter lower limit of the video acquisition device may include: determining the step size based on a distance between a target subject entering into a monitoring region of the video acquisition device and the video acquisition device.

In some embodiments, the obtaining the step size for adjusting the exposure parameter lower limit of the video acquisition device may include: determining, based on a reference image frame, a reflectivity level of a target subject entering into a monitoring region of the video acquisition device, and determining the step size based on the reflectivity level.

In some embodiments, the determining, based on a reference image frame, a reflectivity level of a target subject entering into a monitoring region of the video acquisition device may include: determining the reflectivity level of the target subject based on pixel information of a region in the reference image frame corresponding to the target subject and/or pixel information of the reference image frame.

In some embodiments, the determining the reflectivity level of the target subject based on pixel information of a region in the reference image frame corresponding to the target subject and/or pixel information of the reference image frame may include: dividing the reference image frame into at least one image block; determining one or more target image blocks to which the target subject belongs, wherein the one or more target image blocks corresponds to the region in the reference image frame corresponding to the target subject; and determining the reflectivity level of the target subject based on pixel information of the one or more target image blocks and/or the pixel information of the reference image frame.

In some embodiments, the determining the reflectivity level of the target subject based on pixel information of the one or more target image blocks and/or the pixel information of the reference image frame may include: in response to determining that the reference image frame is a color image, determining a brightness variance of the one or more target image blocks based on the pixel information of the one or more target image blocks and the pixel information of the reference image frame, and determining the reflectivity level of the target subject based on the brightness variance of the one or more target image blocks.

In some embodiments, the determining the reflectivity level of the target subject based on pixel information of the one or more target image blocks and/or the pixel information of the reference image frame may include: in response to determining that the reference image frame is a black and white image, determining a similarity level between pixel information of each of the one or more target image blocks and pixel information of the reference image frame under a pure infrared light source, and determining, based on a count of image blocks in the one or more target image blocks that meet a similarity condition and a count of the one or more target image blocks, the reflectivity level of the target subject.

In some embodiments, the adjusting an exposure parameter of the video acquisition device from the second exposure parameter to a target exposure parameter by adjusting an exposure parameter lower limit of the video acquisition device may include: adjusting the exposure parameter of the video acquisition device from the second exposure parameter to the target exposure parameter by iteratively increasing the exposure parameter lower limit until a termination condition is satisfied, after each increase in the exposure parameter lower limit, an intermediate exposure parameter lower limit, an intermediate exposure parameter, and an intermediate image frame being determined, wherein the termination condition includes the intermediate exposure parameter being equal to the first exposure parameter, or a brightness of the intermediate image frame being equal to a brightness of the first image frame.

In some embodiments, the second exposure parameter may be greater than the exposure parameter lower limit, and the increase of the exposure parameter lower limit may include a first stage and a second stage. In the first stage, the intermediate exposure parameter lower limit may be less than or equal to the second exposure parameter, in the second stage, the intermediate exposure parameter lower limit may be greater than the second exposure parameter, and a difference between two adjacent intermediate exposure parameter lower limits in the first stage may be greater than a difference between two adjacent intermediate exposure parameter lower limits in the second stage.

In some embodiments, the adjusting an exposure parameter of the video acquisition device from the second exposure parameter to a target exposure parameter by adjusting an exposure parameter lower limit of the video acquisition device may include: adjusting the exposure parameter of the video acquisition device from the second exposure parameter to the target exposure parameter by iteratively increasing the exposure parameter lower limit until a termination condition is satisfied, wherein an intermediate exposure parameter lower limit and an intermediate exposure parameter may be determined after each increase in the exposure parameter lower limit. The method may further include: after each increase in the exposure parameter lower limit, obtaining an intermediate image frame collected by the video acquisition device based on the intermediate exposure parameter; determining whether a brightness of the intermediate image frame is greater than a target brightness of the video acquisition device; in response to determining that the brightness of the intermediate image frame is greater than the target brightness, reducing a brightness gain of the video acquisition device so that the brightness of the intermediate image frame is not greater than the target brightness.

In some embodiments, the termination condition may include the brightness gain of the video acquisition device being equal to 0 dB.

In some embodiments, the method may further include: determining whether the first exposure parameter is greater than a threshold; and in response to determining that the first exposure parameter is greater than the threshold, executing the method for video acquisition.

In some embodiments, a difference between a brightness of the target image frame and a brightness of the first image frame is less than a brightness threshold.

One embodiment of the present disclosure provides a system for video acquisition. The system may include a first exposure parameter acquisition module, a second exposure parameter acquisition module, an adjustment module, and a collection module. The first exposure parameter acquisition module may be configured to obtain a first exposure parameter of a video acquisition device when the video acquisition device acquires a first image frame. The second exposure parameter acquisition module may be configured to obtain a second exposure parameter used by the video acquisition device to acquire a second image frame, wherein the second exposure parameter is smaller than the first exposure parameter. The adjustment module may be configured to adjust an exposure parameter of the video acquisition device from the second exposure parameter to a target exposure parameter by adjusting an exposure parameter lower limit of the video acquisition device, wherein the target exposure parameter matches the first exposure parameter. The collection module may be configured to cause, based on the target exposure parameter, the video acquisition device to acquire a target image frame.

One embodiment of the present disclosure provides a device for video acquisition. The device may include a processor configured to implement the method for video acquisition.

One embodiment of the present disclosure provides a non-transitory computer-readable storage medium storing one or more computer instructions, wherein when a computer reads the one or more computer instructions from the storage medium, the computer executes the method for video acquisition.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary application scenario of a system for video acquisition according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary modules of a system for video acquisition according to some embodiments of the present disclosure;

FIG. 4 is a flowchart illustrating an exemplary process for video acquisition according to some embodiments of the present disclosure;

FIG. 5 is a schematic diagram illustrating an exemplary process of eliminating flashing in an image frame caused by flashing of a flashlight according to some embodiments of the present disclosure;

FIG. 6 is a schematic diagram illustrating an adjustment of an exemplary exposure parameter lower limit according to some embodiments of the present disclosure;

FIG. 7 is a flowchart illustrating an exemplary process for determining a reflectivity level of a target subject according to some embodiments of the present disclosure;

FIGS. 8(a) and 8(b) are schematic diagrams illustrating exemplary image blocks according to some embodiments of the present disclosure;

FIG. 9 is a schematic diagram illustrating an exemplary electronic device according to some embodiments of the present disclosure; and

FIG. 10 is a schematic diagram illustrating an exemplary non-transitory computer-readable storage medium according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed from these processes.

When a video acquisition device detects a target subject in a monitoring region of the video acquisition device, the video acquisition device may control a flashlight to flash to alert against the target subject. However, the flashing of the flashlight may cause flashing between light and dark in a monitoring environment, ultimately leading to flashing between light and dark in an image frame (e.g., a subsequent image frame acquired before the flashing) acquired by the video acquisition device, thereby introducing a blind spot and negative effects to the monitoring. In some embodiments, by reducing the exposure time of the video acquisition device before the flashing, a time interval from an end of the exposure of a previous image frame to a start of the exposure of the subsequent frame may be increased. The flashlight may flash during the time interval, and a monitoring effect of no flashing in the subsequent image may be achieved.

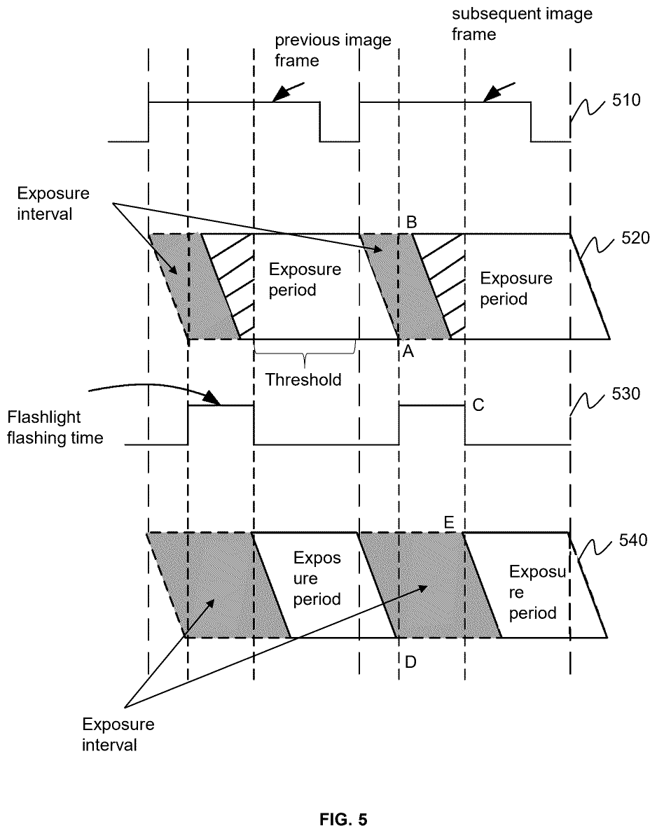

For example, FIG. 5 is a schematic diagram illustrating an exemplary process of eliminating flashing in an image frame caused by flashing of a flashlight according to some embodiments of the present disclosure. FIG. 5 shows an exposure interval and an exposure period of each image frame (e.g., a previous image frame and a subsequent image frame). As shown in FIG. 5, 510 represents a frame sequence of a video acquisition device indicating the time sequence for acquiring different image frames, 520 represents an exposure timing diagram of the video acquisition device for acquiring different image frames in 510 without adjustment of the exposure time, 530 represents a flashing timing diagram of the flashlight of the video acquisition device for acquiring different image frames in 510, and 540 represents an exposure timing diagram of the video acquisition device for acquiring different image frames in 510 after adjustment of exposure time.

Referring to 520 and 530, when a target subject triggers an alert, the flashlight starts to light up from an end of exposure of a last row of the previous image frame (e.g., time point A). Due to the duration of the alert, a time point when the flashlight is extinguished at an end of the alert (e.g., time point C) may be after a time point when a first row of the subsequent image frame begins exposure (e.g., time point B), resulting in flashing between light and dark in a real-time image (e.g., flashing between time points B and C). To eliminate the flashing, as shown in 540, the exposure period of each row of the current frame may be shortened, and the time interval from the end of exposure of the last row of the previous image frame (e.g., time point D) to the beginning of exposure of the first row of the subsequent image frame (e.g., time point E) may be increased. The time interval (e.g., the time interval between time points D and E) may be used for flashlight alert flashing, thereby achieving monitoring without flashlight flashing in a single image frame. The process for eliminating the flashing in an image frame caused by flashing of a flashlight may also be referred to as an anti-flashing strategy.

However, as the exposure time (i.e., shutter value) is sacrificed, when the alert ends and an environment stabilizes, if the exposure time is still the sacrificed exposure time, an image brightness may remain darker due to the sacrifice of the exposure time (i.e., the shutter value), the monitoring effectiveness may be affected. In some embodiments, a brightness gain may be increased to increase the brightness of the subsequent image frame, but the increase of the brightness gain may increase image noise and degrade image quality. In some embodiments, the exposure time may be directly adjusted to the exposure time before the alert is triggered or the flashing, but the increase of the exposure time may cause abrupt changes in the image brightness, affecting user experience. Additionally, when a subject repeatedly enters and exits a boundary of an alert region of the video acquisition device, the alert effect may be continuously triggered, causing the flashlight to repeatedly illuminate and extinguish, resulting in repeated flashing of the image brightness.

Therefore, some embodiments of the present disclosure propose a method for video acquisition to ensure image quality while achieving exposure recovery and improving video monitoring effectiveness. It may be understood that some embodiments of the present disclosure apply not only to exposure adaptive recovery for an alert camera but also to situations where exposure parameters of the previous and subsequent image frames are different due to other reasons. For illustrative purposes, the following description focuses on exposure adaptive recovery for the alert camera.

It should be noted that in the specific embodiments of the present disclosure, relevant data related to monitoring images, target subjects, etc., when applied to specific products or technologies, require user permission or consent. Moreover, the collection, use, and processing of the relevant data need to comply with relevant laws, regulations, and standards of the respective countries and regions.

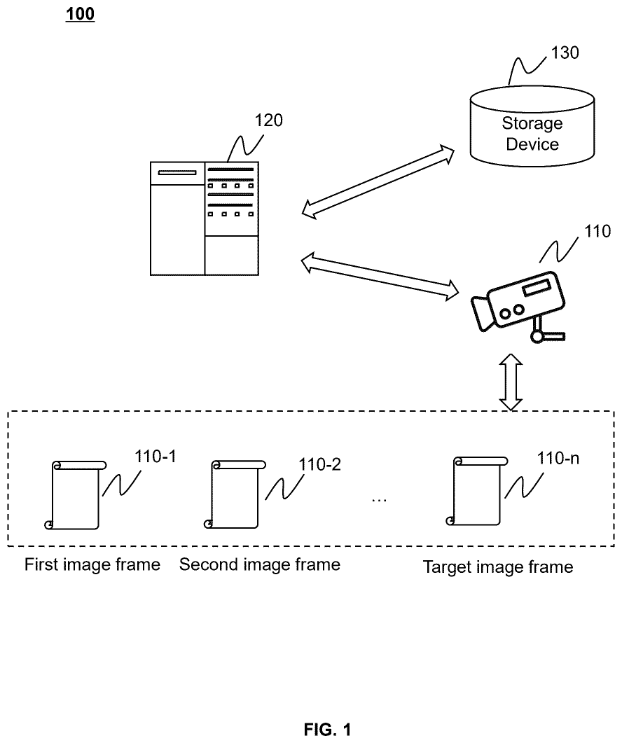

FIG. 1 is a schematic diagram illustrating an exemplary application scenario of a system for video acquisition according to some embodiments of the present disclosure. In some embodiments, a system 100 for video acquisition (also referred to as a video acquisition system 100) may include a video acquisition device 110, a processing device 120, and a storage device 130. In some embodiments, the video acquisition system 100 may also include a network and/or a terminal device (not shown in the drawings).

The video acquisition device 110 may be configured to collect image data (e.g., an image and/or a video). The video acquisition device 110 may include a structured light depth camera, a time-of-flight depth camera, a stereo camera, etc. For example, the video acquisition device 110 may be configured to collect a video including a first image frame 110-1, a second image frame 110-2, . . . , and a target image frame 110-n. In some embodiments, the video acquisition device 110 may include a stereo camera. The stereo camera may include a projector and two detectors. The projector may project structured light (e.g., infrared light) of a certain pattern onto a surface of a subject in a monitoring region, and the detectors may receive the light reflected from the surfaces of the subject in the monitoring region, thereby obtaining image data modulated by a shape of the surface of the subject in the monitoring region. The structured light emitted by the projector may include stripe-structured light, dot-structured light, chessboard-structured light, or any other form of structured light. In some embodiments, the camera in the video acquisition device 110 may include one projector and one detector. In some embodiments, the video acquisition device may also include other types of depth cameras.

In some embodiments, the video acquisition device 110 may capture a color image when ambient light is sufficient and capture a black and white image when the ambient light is insufficient, supplemented by an infrared light source.

In some embodiments, the video acquisition device 110 may be an alert camera. The alert camera may be capable of accurately detecting and tracking a subject (e.g., the human body), implementing detection, analysis, and recognition of subject (e.g., the human body), and issuing a real-time alert when detecting that the subject enters the alert region of the video acquisition device 110. When a target subject enters a monitoring region, the target subject may be automatically tracked and identified, and a flashlight flashes to alert the target subject when the target subject enters the alert region. The alert region may be the same as the monitoring region or be a portion of the monitoring region of the video acquisition device 110.

In some embodiments, the video acquisition device 110 may automatically adjust an exposure parameter based on an auto exposure (AE) algorithm during image data acquisition. For example, the video acquisition device 110 may determine a brightness of a current image frame acquired according to a current exposure parameter (e.g., the exposure time, the brightness gain), and determine whether the brightness of the current image frame falls within a target brightness range. If the brightness of a current image frame is not within the target brightness range, the current exposure parameter may be adjusted to obtain an adjusted exposure parameter until the brightness of the current image frame is within the target brightness range. The adjusted exposure parameter may be used to acquire a subsequent image frame and the brightness of the subsequent image frames may fall within the target brightness range.

In some embodiments, the exposure parameter may include an exposure time (also referred to as shutter speed or shutter value), a shutter line number, etc.

In some embodiments, the exposure parameter of the video acquisition device 110 may correspond to a reference value or a reference range. The reference value or range of an exposure parameter may be configured to limit the exposure parameter during the adjustment of the exposure parameter, and the exposure parameter needs to meet the reference value or range. For example, the brightness may correspond to a target brightness range and the brightness of an image frame acquired by the video acquisition device 110 may need to be within the target brightness range. As another example, the exposure time may correspond to an exposure time lower limit and an exposure time upper limit. The exposure time may need to be greater than or equal to the exposure time lower limit and less than or equal to the exposure time upper limit. As still another example, the shutter line number may correspond to a shutter line lower limit and a shutter line upper limit. The shutter line number may be between the shutter line lower limit and the shutter line upper limit. The exposure time and the shutter line number may satisfy a relationship represented as an equation (1):

$$Line = Time \times FPS \times VTS , \qquad ( 1 )$$

wherein Line represents the shutter line number, Time represents the exposure time, FPS represents a frame rate, and VTS represents a frame length.

From equation (1), it may be seen that the exposure time and the shutter line number are directly proportional. In some embodiments, since the exposure time is also referred to as the shutter speed, adjusting the exposure parameter may include adjusting the shutter speed, and when adjusting the shutter speed, the shutter line number may be adjusted along with the adjustment of the shutter speed. In some embodiments, adjusting the exposure parameter may include adjusting the shutter line number, and when adjusting the shutter line number, the exposure time may be adjusted along with the adjustment of the shutter line number.

The processing device 120 may adjust and restore the exposure parameter of the video acquisition device 110. In some embodiments, the processing device 120 may obtain a first exposure parameter corresponding to a first image frame collected by the video acquisition device and a second exposure parameter corresponding to a second image frame collected by the video acquisition device. The processing device 120 may adjust the exposure parameter of the video acquisition device by adjusting an exposure parameter lower limit, thereby adjusting the exposure parameter of the video acquisition device adjusted from the second exposure parameter to a target exposure parameter. The processing device 120 may obtain a target image frame acquired by the video acquisition device based on the target exposure parameter. In some embodiments, the processing device 120 may be integrated with the video acquisition device 110.

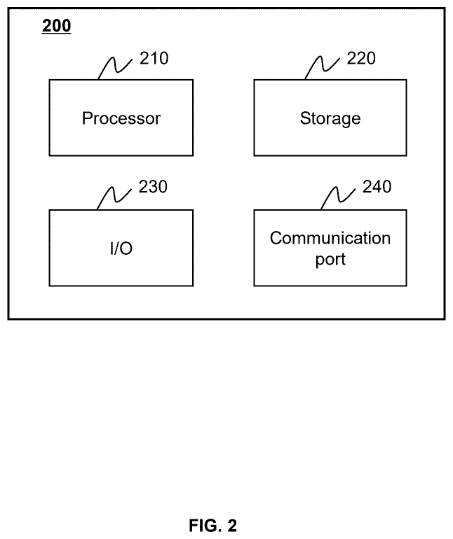

In some embodiments, the processing device 120 may be a single server or a server group. The server group may be centralized or distributed. In some embodiments, the processing device 120 may be local or remote. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 120 may be implemented by a computing device 200 having one or more components illustrated in FIG. 2.

The network may include any suitable network that facilitates the exchange of information and/or data. For example, the processing device 120 and the storage device may exchange information and/or data via the network.

In some embodiments, the network may be or include a public network (e.g., the Internet), a private network (e.g., a local area network (LAN)), a wired network, a wireless network (e.g., an 802.11 network, a Wi-Fi network), a frame relay network, a virtual private network (VPN), a satellite network, a telephone network, routers, hubs, switches, server computers, and/or any combination thereof. For example, the network may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network may include one or more network access points. For example, the network may include wired and/or wireless network access points such as base stations and/or internet exchange points through which one or more components of the system 100 for video acquisition may be connected to the network to exchange data and/or information.

The storage device 130 may store data, instructions, and/or any other information. In some embodiments, the storage device may store data and/or instructions related to exposure adaptive recovery. For example, the storage device may store the first exposure parameter. As another example, the storage device may store an instruction for processing the exposure parameter lower limit for video acquisition. In some embodiments, the storage device may include a mass storage, removable storage, a volatile read-and-write memory, a read-only memory (ROM), or the like, or any combination thereof. In some embodiments, the storage device may be implemented on a cloud platform. In some embodiments, the storage device may integrated into the processing device 120 and/or the terminal device.

In some embodiments, the storage device may be connected to the network to communicate with one or more other components of the system 100 for video acquisition (e.g., the processing device 120, the video acquisition device 110, the terminal device, etc.). One or more components of the system 100 for video acquisition may access data or instructions stored in the storage device via the network.

In some embodiments, a user may interact with the system for video acquisition through the terminal device. In some embodiments, the processing device 120 may be part of the terminal device. The terminal device may include an embedded device with a relatively small storage capacity. In some embodiments, the terminal device may include an embedded device with a relatively small storage capacity. In some embodiments, the terminal device may include a smart phone, a smart camera, a smart audio, a smart TV, a smart fridge, a robot, a tablet, a laptop, a wearable, a payment device, a cashier device, or the like, or any combination thereof.

It should be noted that the description provided above regarding the system 100 for video acquisition is merely illustrative and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the system 100 for video acquisition may include one or more additional components, and/or one or more components of the system 100 for video acquisition described above may be omitted. Additionally or alternatively, two or more components of the system 100 for video acquisition may be integrated into a single component. A component of the system 100 for video acquisition may be implemented on two or more sub-components.

FIG. 2 is a schematic diagram illustrating exemplary hardware and/or software components of an exemplary computing device according to some embodiments of the present disclosure. In some embodiments, the processing device 120 and/or the terminal device may be implemented on a computing device 200. As illustrated in FIG. 2, the computing device 200 may include a processor 210, a storage 220, an input/output (I/O) 230, and a communication port 240.

The processor 210 may execute computer instructions (e.g., program code) and perform functions of the processing device 120 in accordance with techniques describable herein. The computer instructions may include, for example, routines, programs, objects, components, data structures, procedures, modules, and functions, which perform particular functions describable herein.

In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely by way of example, only one processor is describable in the computing device 200. However, it should be noted that the computing device 200 in the present disclosure may also include multiple processors, thus operations and/or method operations that are performed by one processor as describable in the present disclosure may also be jointly or separately performed by the multiple processors. For example, if in the present disclosure, the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data obtained from one or more components of the system 100 for video acquisition. In some embodiments, the storage 220 may include a mass storage device, a removable storage device, a volatile read-and-write memory, a read-only memory (ROM), or the like, or any combination thereof. In some embodiments, the storage 220 may store one or more programs and/or instructions to perform exemplary methods describable in the present disclosure. For example, the storage 220 may store a program for the processing device 120 to execute to compress the machine learning model.

The I/O 230 may input and/or output signals, data, information, etc. In some embodiments, the I/O 230 may enable a user interaction with the processing device 120. In some embodiments, the I/O 230 may include an input device and an output device. The input device may include a keyboard, a touch screen, a speech input, an eye tracking input, a brain monitoring system, or any other comparable input mechanism. The input information received through the input device may be transmitted to another component (e.g., the processing device 120) via, for example, a bus, for further processing. Other types of the input devices may include a cursor control device, such as a mouse, a trackball, or cursor direction keys, etc. The output device may include a display (e.g., a liquid crystal display (LCD), a light-emitting diode (LED)-based display, a flat panel display, a curved screen, a television device, a cathode ray tube (CRT), a touch screen), a speaker, a printer, or the like, or a combination thereof.

The communication port 240 may be connected to a network (e.g., the network 130) to facilitate data communications. The communication port 240 may establish connections between the processing device 120 and the terminal device. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G), or the like, or a combination thereof. In some embodiments, the communication port 240 may be and/or include a standardized communication port, such as RS232, RS485, etc. In some embodiments, the communication port 240 may be a specially designed communication port.

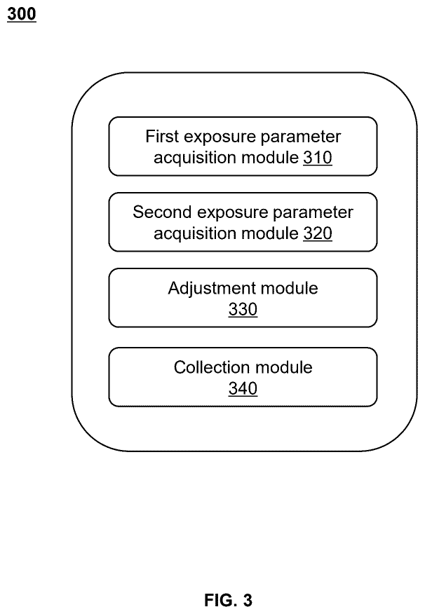

FIG. 3 is a schematic diagram illustrating exemplary modules of a system for video acquisition according to some embodiments of the present disclosure. In some embodiments, a system 300 for video acquisition may include a first exposure parameter acquisition module 310, a second exposure parameter acquisition module 320, an adjustment module 330, and a collection module 340.

The first exposure parameter acquisition module 310 may be configured to obtain a first exposure parameter of a video acquisition device when the video acquisition device acquires a first image frame.

The second exposure parameter acquisition module 320 may be configured to obtain a second exposure parameter used by the video acquisition device to acquire a second image frame, wherein the second exposure parameter is less than the first exposure parameter.

The adjustment module 330 may be configured to adjust an exposure parameter of the video acquisition device by adjusting an exposure parameter lower limit, so that the exposure parameter of the video acquisition device is adjusted from the second exposure parameter to a target exposure parameter, wherein the target exposure parameter matches the first exposure parameter.

In some embodiments, the adjustment module 330 may be further configured to: obtain a step size for adjusting the exposure parameter lower limit of the video acquisition device and adjust the exposure parameter lower limit based on the step size. In some embodiments, the adjustment module 330 may be further configured to: determine the step size based on a distance between a target subject entering into a monitoring region of the video acquisition device and the video acquisition device. In some embodiments, the adjustment module 330 may be further configured to: determine, based on a reference image frame, a reflectivity level of a target subject entering into a monitoring region of the video acquisition device, and determine the step size based on the reflectivity level. In some embodiments, the adjustment module 330 may be further configured to: determine the reflectivity level of the target subject based on pixel information of a region in the reference image frame corresponding to the target subject and/or pixel information of the reference image frame. In some embodiments, the adjustment module 330 may be further configured to: divide the reference image frame into at least one image block, determine one or more target image blocks to which the target subject belongs, wherein the one or more target image blocks corresponds to the region in the reference image frame corresponding to the target subject, and determine the reflectivity level of the target subject based on pixel information of the one or more target image blocks and/or the pixel information of the reference image frame. In some embodiments, the adjustment module 330 may be further configured to: in response to determining that the reference image frame is a color image, determine a brightness variance of the one or more target image blocks based on the pixel information of the one or more target image blocks and the pixel information of the reference image frame, and determine the reflectivity level of the target subject based on the brightness variance of the one or more target image blocks. In some embodiments, the adjustment module 330 may be further configured to: in response to determining that the reference image frame is a black and white image, determine a similarity level between pixel information of each of the one or more target image blocks and pixel information of the reference image frame under a pure infrared light source, and determine, based on a count of image blocks in the one or more target image blocks that satisfy a similarity condition and a count of the one or more target image blocks, the reflectivity level of the target subject.

In some embodiments, the adjustment module 330 may be further configured to: adjust the exposure parameter of the video acquisition device from the second exposure parameter to the target exposure parameter by iteratively increasing the exposure parameter lower limit until a termination condition is satisfied, after each increase in the exposure parameter lower limit, an intermediate exposure parameter lower limit, an intermediate exposure parameter, and an intermediate image frame being determined, wherein the termination condition may include the intermediate exposure parameter being equal to the first exposure parameter, or a brightness of the intermediate image frame being equal to a brightness of the first image frame. In some embodiments, the second exposure parameter may be greater than the exposure parameter lower limit, and the increase of the exposure parameter lower limit may include a first stage and a second stage. In the first stage, the intermediate exposure parameter lower limit may be less than or equal to the second exposure parameter, in the second stage, the intermediate exposure parameter lower limit may be greater than the second exposure parameter, and a difference between two adjacent intermediate exposure parameter lower limits in the first stage may be greater than a difference between two adjacent intermediate exposure parameter lower limits in the second stage.

In some embodiments, the adjustment module 330 may be further configured to: adjust the exposure parameter of the video acquisition device from the second exposure parameter to the target exposure parameter by iteratively increasing the exposure parameter lower limit until a termination condition is satisfied, wherein an intermediate exposure parameter lower limit and an intermediate exposure parameter may be determined after each increase in the exposure parameter lower limit. In some embodiments, the adjustment module 330 may be further configured to: after each increase in the exposure parameter lower limit, obtain an intermediate image frame collected by the video acquisition device based on the intermediate exposure parameter; determine whether a brightness of the intermediate image frame is greater than a target brightness of the video acquisition device; in response to determining that the brightness of the intermediate image frame is greater than the target brightness, reduce a brightness gain of the video acquisition device so that the brightness of the intermediate image frame is not greater than the target brightness. In some embodiments, the termination condition may include the brightness gain of the video acquisition device being equal to 0 dB.

The collection module 340 may be configured to cause, based on the target exposure parameter, the video acquisition device to acquire a target image frame. In some embodiments, a difference between a brightness of the target image frame and a brightness of the first image frame may be less than a brightness threshold.

In some embodiments, the system 300 for video acquisition may further include a determination module (not shown in the drawings). The determination module may be configured to determine whether the first exposure parameter is greater than a predetermined threshold; and in response to the second exposure parameter being greater than the predetermined threshold, execute the method for video acquisition described in the embodiments of the present disclosure.

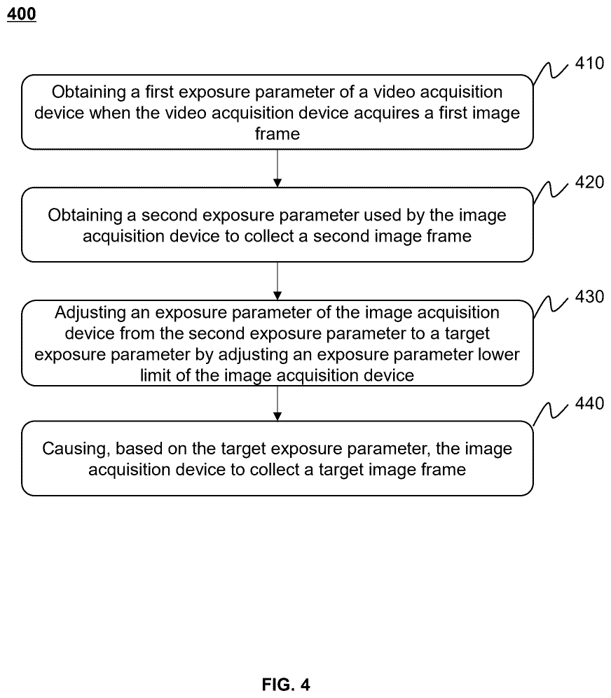

More descriptions of the first exposure parameter acquisition module 310, the second exposure parameter acquisition module 320, the adjustment module 330, and the collection module 340 may be found in FIGS. 4 to 10 and the corresponding descriptions thereof.

It should be noted that the above descriptions of the system 300 for video acquisition are provided for the purposes of illustration, and not intended to limit the scope of the present disclosure. For persons having ordinary skills in the art, various modifications and changes in the forms and details of the application of the above method and system may occur without departing from the principles of the present disclosure. In some embodiments, the system 300 for video acquisition may include one or more other modules and/or one or more modules described above may be omitted. Additionally or alternatively, two or more modules may be integrated into a single module and/or a module may be divided into two or more units. However, those variations and modifications also fall within the scope of the present disclosure.

FIG. 4 is a flowchart illustrating an exemplary process for video acquisition according to some embodiments of the present disclosure. In some embodiments, process 400 may be executed by the system 100 for video acquisition. For example, the process 400 may be implemented as a set of instructions stored in a storage device. In some embodiments, the processing device 120 (e.g., the processor 210 of the computing device 200 and/or one or more modules illustrated in FIG. 3) may execute the set of instructions and may accordingly be directed to perform the process 400. The operations of the illustrated process presented below are intended to be illustrative. In some embodiments, the process 400 may be accomplished with one or more additional operations not described and/or without one or more of the operations discussed. Additionally, the order of the operations of process 400 illustrated in FIG. 4 and described below is not intended to be limiting.

In 410, a first exposure parameter corresponding to a first image frame acquired by a video acquisition device may be obtained. Operation 410 may be executed by the processing device 120 or the first exposure parameter acquisition module 310.

In some embodiments, the first image frame may include an image frame of a video collected by the video acquisition device before the flashing of a flashlight (e.g., when an alert is triggered). In some embodiments, the first image frame may be any image frame collected by the video acquisition device before a current time. For example, the first image frame may be an adjacent image frame before the flashing of a flashlight (e.g., when an alert is triggered). In some embodiments, the first image frame may be an image frame collected by the video acquisition device before the current time with an exposure parameter meeting certain conditions. For example, a brightness of the first image frame is within a target brightness range. As another example, an exposure time of the first image frame is not sacrificed. More description for the sacrificing of the exposure time may be found elsewhere in the present disclosure. As yet another example, the exposure time of the first image frame may be within a target time range.

In some embodiments, the first image frame collected by the video acquisition device may include a person, a subject, etc., within a monitoring region. In some embodiments, when a processing device (e.g., the processing device 120 or a control module of the video acquisition device) determines, based on the first image frame, that a target subject is within an alerting region or a distance between the target subject and the video acquisition device may be within a predefined distance, an alert may be triggered, and the flashlight of the video acquisition device may be controlled to flash. The predefined distance may be obtained based on a parameter of the video acquisition device. More descriptions of the video acquisition device may be found in FIG. 1 and the related descriptions thereof.

The first exposure parameter may be the actual exposure parameter of the video acquisition device used to acquire the first image frame. The first exposure parameter may also be referred to as a first value of an exposure parameter (e.g., the exposure time) of the video acquisition device. In some embodiments, the first exposure parameter may be the actual the exposure parameter before the alert is triggered, i.e., the exposure parameter before the flashlight flashes. In some embodiments, the first exposure parameter may include a first exposure time (also referred to as a first shutter value), a first shutter line number, etc. More descriptions of the exposure parameter, the exposure time, the shutter value, and the shutter line number may be found in the previous related descriptions.

In some embodiments, the first exposure parameter may be determined based on the auto exposure (AE) algorithm as described elsewhere in the present disclosure.

In 420, a second exposure parameter used by the video acquisition device to collect a second image frame may be obtained. Operation 420 may be executed by the processing device 120 or the second exposure parameter acquisition module 320.

In some embodiments, the second image frame may be an image frame that the video acquisition device will to acquire at the current time after or during the flashlight flashes. As used herein, the second exposure parameter may be an estimated exposure parameter for acquiring the second image frame. In actual, the second image frame is not acquired according to the second exposure parameter by the video acquisition device, but according to the intermediate exposure parameter that is obtained by adjusting the second exposure parameter according to operation 430. In some embodiments, the second image frame may be a subsequent image frame that will be acquired by the video acquisition device after the first image frame. In some embodiments, the second image frame may be an image that the video acquisition device will to acquire at the current time. For example, the estimated brightness of the second image frame may be not within the target brightness range. As another example, the exposure time of the second image frame may be sacrificed. More descriptions of the video acquisition device may be found in FIG. 1 and the related descriptions thereof.

The second exposure parameter refers to an initial or estimated exposure parameter of the video acquisition device. The second exposure parameter may also be referred to as a second value of the exposure parameter (e.g., the exposure time) of the video acquisition device. The video acquisition device will to or may plan to collect the second image frame according to the initial exposure parameter. In some embodiments, the second exposure parameter refers to the exposure parameter after the alert is triggered, i.e., the exposure parameter after the flashlight flashes. When a target subject enters the alerting region of the video acquisition device, the flashlight of the video acquisition device may start to flash. To avoid the influence of the flashing of the flashlight on a video acquisition process of the video acquisition device, the exposure time of a subsequent image frame (i.e., the second image frame) may be shortened to increase an exposure interval between two adjacent image frames (e.g., the first image frame and the second image frame), so that the flashing of the flashlight may occur between the increased exposure interval. Therefore, the exposure parameter of the video acquisition device may be adjusted from the first exposure parameter for collecting the first image frame to the second exposure parameter. For example, g the first exposure parameter may be reduced to determine the second exposure parameter for the capture of the second image frame. Therefore, the second exposure parameter may be smaller than the first exposure parameter. A difference between the second exposure parameter and the first exposure parameter may be determined based on the duration of the flashing of the flashlight.

In some embodiments, the second exposure parameter may include a second exposure time (also referred to as a second shutter value), a second shutter line number, etc. More descriptions of the exposure parameter, the exposure time, the shutter value, and the shutter line number may be found in the previous related description. It should be noted that the actual exposure parameter used by the video acquisition device to capture the second image frame may be the exposure parameter adjusted by the method described herein in some embodiments, such as an intermediate exposure parameter.

It should be noted that the first exposure parameter and the second exposure parameter are essentially both the exposure parameter of the video acquisition device. The difference between them lies only in the fact that they are taken at different times, so their values may differ. In other words, the first exposure parameter and the second exposure parameter are values of the exposure parameter (e.g., the exposure time) of the video acquisition device at different time periods.

In 430, the exposure parameter of the video acquisition device may be adjusted from the second exposure parameter to a target exposure parameter by adjusting an exposure parameter lower limit of the video acquisition device. Operation 430 may be executed by the processing device 120 or the adjustment module 330.

The target exposure parameter refers to a target value of the exposure parameter obtained by adjusting the second exposure parameter after the flashing of the flashlight, i.e., the exposure parameter adjusted after the flashlight flashes. The target exposure parameter may also be referred to as the target value of the exposure parameter (e.g., the exposure time) of the video acquisition device. In some embodiments, the target exposure parameter may include a target exposure time (also referred to as a target shutter value), a target shutter line number, or the like. More descriptions of the exposure parameter, the exposure time, the shutter value, and the shutter line number may be found in the previous related descriptions.

In some embodiments, the target exposure parameter may match the first exposure parameter. In some embodiments, the matching between the target exposure parameter and the first exposure parameter may refer to that a difference between the target exposure parameter and the first exposure parameter is less than a difference threshold, or the target exposure parameter is equal to the first exposure parameter. In some embodiments, the processing device may determine the difference threshold based on user input.

It should be noted that the difference between the target exposure parameter and the first exposure parameter may include a difference between the first exposure time and the target exposure time, a difference between the first shutter value and the target shutter value, and/or a difference between the first shutter line number and the target shutter line number. The difference threshold may include an exposure time difference threshold, a shutter value difference threshold, and/or a shutter line number difference threshold. Furthermore, there is a corresponding relationship between the exposure time difference threshold, the shutter value difference threshold, and the shutter line number difference threshold.

In order to restore the brightness of image frames collected by the video acquisition device to the brightness of the image frame captured before the flashing of the flashlight, it is necessary to increase the second exposure parameter after the flashing of the flashlight ends. However, if the exposure parameter is directly adjusted, after sacrificing the exposure time to prevent flashing, a stable state with darker image frames may be formed. According to a normal shutter control logic, directly increasing the exposure parameter may result in the brightness of the image frame collected based on the adjusted exposure parameter exceeding a target brightness range of the video acquisition device. The target brightness range may be the default brightness of the video acquisition device to prevent the over-light. If the brightness of an image frame acquired based on the adjusted exposure parameter, the image frame may be determined as too bright, and the processing device may again reduce the exposure parameter to ensure that the brightness of the image frame is within the target brightness range. Therefore, the possible final state of directly adjusting the exposure parameter may be that the exposure parameter may not reach the first exposure parameter, a brightness gain may be reduced, and an adjustment result may not meet an adjustment expectation. Furthermore, directly adjusting the exposure parameter may have minimal impact at a low gain due to the low brightness gain of the image frame, especially in environments close to 0 dB, still failing to meet the requirements. At high gain, adjusting the exposure parameter directly may cause the system to determine the brightness of the image frame as too bright, further reducing the exposure parameter, which may result in a darker image instead. Since the exposure parameter must be greater than the exposure parameter lower limit, the processing device may adjust the exposure parameter lower limit of the video acquisition device to adjust the exposure parameter of the video acquisition device from the second exposure parameter to the target exposure parameter.

The exposure parameter lower limit refers to a minimum exposure parameter allowed for the video acquisition device. Correspondingly, the exposure parameter upper limit refers to a maximum exposure parameter allowed for the video acquisition device.

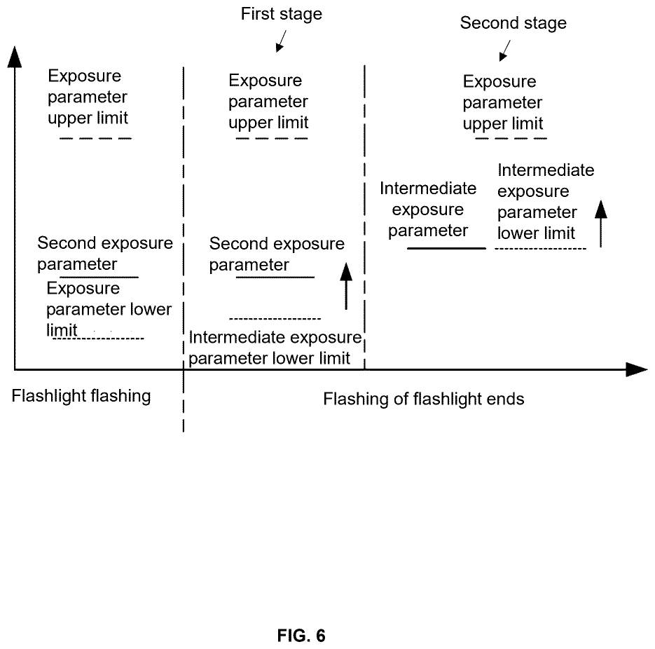

FIG. 6 is a schematic diagram illustrating an adjustment of an exemplary exposure parameter lower limit according to some embodiments of the present disclosure. A light sensor configured for image capture in the video acquisition device usually has an exposure parameter lower limit and an exposure parameter upper limit, and an actual exposure parameter may float between the exposure parameter lower limit and the exposure parameter upper limit. By increasing the exposure parameter lower limit, the exposure parameter may be adjusted by passively following the upward adjustment of the exposure parameter lower limit. This avoids the issue if adjusting the exposure parameter directly, even after increasing the exposure parameter, the adjusted exposure parameter may be reduced again due to the limitation of the target brightness range, rendering the adjustment of the exposure parameter ineffective.

Furthermore, with the increasing of the exposure parameter lower limit until the exposure parameter following the increase of the exposure parameter lower limit match the first exposure parameter, the adjusted exposure parameter matching the first exposure parameter may be determined as the target exposure parameter after exposure recovery, completing the exposure recovery of the video acquisition device. After completing the exposure recovery of the video acquisition device, if no target subject enters the monitoring region of the video acquisition device, the increased exposure parameter lower limit may be restored to the initial exposure parameter lower limit. The initial exposure parameter lower limit refers to the exposure parameter lower limit before adjustment, the exposure parameter lower limit before the flashing of the flashlight.

In some embodiments, the processing device may increase the exposure parameter lower limit multiple times until a termination condition is satisfied so that the exposure parameter of the video acquisition device is adjusted from the second exposure parameter to the target exposure parameter. After each increase in the exposure parameter lower limit, an intermediate exposure parameter lower limit and an intermediate exposure parameter may be generated. The video acquisition device may acquire an intermediate image frame based on the intermediate exposure parameter.

The intermediate exposure parameter lower limit refers to an adjusted value of the exposure parameter lower limit during the adjustment process of the exposure parameter lower limit. In some embodiments, during the multiple times of increasing of the exposure parameter lower limit, multiple intermediate exposure parameter lower limits may be generated or determined. For example, after a first increase in the exposure parameter lower limit, the processing device may generate a first intermediate exposure parameter lower limit; after a second increase in the exposure parameter lower limit, the processing device may generate a second intermediate exposure parameter lower limit until the exposure parameter lower limit may be adjusted to the target exposure parameter lower limit.

The intermediate exposure parameter refers to an adjusted value of the exposure parameter of the video acquisition device during the adjustment process of the exposure parameter lower limit. In some embodiments, multiple intermediate exposure parameters may be generated during the adjustment process of the exposure parameter. For example, after the first increase in the exposure parameter lower limit, the processing device may generate a first intermediate exposure parameter as an actual exposure parameter for collecting a second image frame; after the second increase in the exposure parameter lower limit, the processing device may generate a second intermediate exposure parameter until the exposure parameter is adjusted to the target exposure parameter. In some embodiments, the second exposure parameter may be greater than the exposure parameter lower limit. Before increasing the exposure parameter lower limit to equal the second exposure parameter, the exposure parameter of the video acquisition device may remain unchanged, i.e., the intermediate exposure parameter is equal to the second exposure parameter, until the intermediate exposure parameter lower limit is greater than the second exposure parameter. After increasing the exposure parameter lower limit to be greater than the second exposure parameter, the exposure parameter of the video acquisition device may increase with the increase of the exposure parameter lower limit, and the intermediate exposure parameter is equal to the intermediate exposure parameter lower limit.

The intermediate image frame refers to an image frame acquired by the video acquisition device based on the intermediate exposure parameter during the adjustment process of the exposure parameter lower limit. In some embodiments, multiple intermediate image frames may be acquired by the video acquisition device during the adjustment process. For each increase in the exposure parameter lower limit, an intermediate image frame may be generated. For example, after the first increase in the exposure parameter lower limit, the video acquisition device may collect a first intermediate image frame; after the second increase in the exposure parameter lower limit, the video acquisition device may collect a second intermediate image frame, until the image frame is adjusted to the target image frame.

In some embodiments, the processing device may increase the exposure parameter lower limit multiple times by increasing the exposure parameter lower limit each time by a fixed step size or a variable step size. The step size refers to a numerical difference between the exposure parameter lower limits adjusted in adjacent two adjustments. More descriptions of the step size may be found in the following related descriptions.

In some embodiments, when the second exposure parameter is greater than the exposure parameter lower limit, increasing the exposure parameter lower limit multiple times may include a first stage and a second stage.

The first stage refers to a stage where the intermediate exposure parameter lower limit is less than or equal to the second exposure parameter during the adjustment of the exposure parameter lower limit. As shown in FIG. 6, the intermediate exposure parameter lower limit in the second column is less than the second exposure parameter, and the second column represents the first stage.

The second stage refers to a stage where the intermediate exposure parameter lower limit is greater than the second exposure parameter during the adjustment of the exposure parameter lower limit. As shown in FIG. 6, the intermediate exposure parameter lower limit in the third column is greater than the second exposure parameter, and the third column represents the second stage.

In some embodiments, a difference between two adjacent intermediate exposure parameter lower limits in the first stage may be greater than a difference between two adjacent intermediate exposure parameter lower limits in the second stage, i.e., the step size in the first stage is greater than the step size in the second stage.

As shown in FIG. 6, in the first stage, since the intermediate exposure parameter lower limit is less than or equal to the second exposure parameter, the exposure parameter of the video acquisition device remains unchanged at the second exposure parameter during the process of increasing the intermediate exposure parameter lower limit. Therefore, in the first stage, a larger step size may be set to increase a recovery speed of the exposure parameter. In the second stage, since the intermediate exposure parameter lower limit is greater than the second exposure parameter, the exposure parameter of the video acquisition device changes during the process of increasing the intermediate exposure parameter lower limit, i.e., the exposure parameter of the video acquisition device is adjusted from the second exposure parameter to the target exposure parameter. Therefore, in the second stage, a smaller step size may be set to prevent sudden changes in the exposure parameter leading to abrupt changes in image brightness.

The termination condition refers to a condition for stopping the increase of the exposure parameter lower limit. In some embodiments, the termination condition may include the intermediate exposure parameter being equal to the first exposure parameter, or the brightness of the intermediate image frame being equal to the brightness of the first image frame.

It should be noted that the first exposure parameter is the exposure parameter of the video acquisition device before the flashing of the flashlight, so the first exposure parameter is equivalent to a baseline value for determining whether the exposure has been restored. After the flashing of the flashlight ends, the exposure parameter lower limit may gradually increase, causing the exposure parameter to increase gradually, and the brightness of the intermediate image frame gradually to increase until the intermediate exposure parameter is equal to the first exposure parameter, or the brightness of the intermediate image frame is equal to the brightness of the first image frame, and this intermediate exposure parameter may be determined as the target exposure parameter.

In some embodiments, the termination condition may include a condition, such as the intermediate exposure parameter matching the first exposure parameter in addition to being equal to the first exposure parameter. More descriptions of the intermediate exposure parameter matching the first exposure parameter may be found in the preceding related description.

In some embodiments, the processing device may increase the exposure parameter lower limit multiple times until the termination condition is satisfied, so as to adjust the exposure parameter of the video acquisition device from the second exposure parameter to the target exposure parameter. After each increase in the exposure parameter lower limit, an intermediate exposure parameter lower limit and an intermediate exposure parameter may be generated. Furthermore, after generating the intermediate exposure parameter lower limit with each increase in the exposure parameter lower limit, the processing device may further perform operations S1 to S3. More descriptions of the multiple increases in the exposure parameter lower limit may be found in the preceding related description.

In S1, the processing device may obtain the intermediate image frame acquired by the video acquisition device based on the intermediate exposure parameter. The intermediate exposure parameter may be the actual exposure parameter to acquire the intermediate image frame. More descriptions of the intermediate image frame may be found in the preceding related description.

In S2, the processor may determine whether the brightness of the intermediate image frame is greater than a target brightness of the video acquisition device. More descriptions of the target brightness may be found in the preceding related description.

In S3, in response to determining that the brightness of the intermediate image frame is greater than the target brightness or outside the target brightness range, the processor may reduce a brightness gain of the video acquisition device so that the brightness of the intermediate image frame is not greater than the target brightness.

The brightness gain refers to a parameter used to enhance the brightness of a monitoring image. It may be understood that during the process of multiple increases in the exposure parameter lower limit to adjust the exposure parameter of the video acquisition device from the second exposure parameter to the target exposure parameter, the brightness of the intermediate image frame may gradually increase. When the brightness of the intermediate image frame is greater than the target brightness, the processing device may reduce the brightness gain of the video acquisition device to ensure that the brightness of an intermediate image frame generated in the next increase is not greater than the target brightness.

In some embodiments, the termination condition may include the brightness gain of the video acquisition device being equal to 0 db.

It may be understood that in response to determining that the brightness of the intermediate image frame is greater than the target brightness, the brightness gain of the video acquisition device may be reduced so that the brightness of the intermediate image frame is not greater than the target brightness. If the brightness gain of the video acquisition device has already been reduced to 0 db in the above process, considering that the duration of the flashing of the flashlight is usually short, the change in the exposure parameter corresponding to the flashing of the flashlight in a high-brightness environment is not very significant compared to the first exposure parameter before the flashing of the flashlight. Therefore, it is possible to terminate the exposure recovery process prematurely. At this point, the exposure parameter of the video acquisition device may not have been fully restored to the first exposure parameter. In other words, the target exposure parameter may be not equal to or less than the first exposure parameter.

In some embodiments, the termination condition may include, for example, the intermediate exposure parameter matching the first exposure parameter, or the brightness of the intermediate image frame being equal to the brightness of the first image frame. The present disclosure does not impose limitations in this regard. More descriptions of the termination condition may be found in the preceding related description.

In some embodiments, the processing device may obtain a step size for adjusting the exposure parameter lower limit of the video acquisition device and adjust the exposure parameter lower limit based on the step size.

The step size refers to the amount of adjustment for each adjustment of the exposure parameter lower limit, i.e., the numerical value between the exposure parameter lower limits adjusted in adjacent adjustments. In some embodiments, the step sizes corresponding to the multiple increases in the exposure parameter lower limit may be the same or different.

In some embodiments, the processing device may set a fixed step size. By reducing the step size, the processing device may increase a count of adjustments to minimize the brightness change caused by each adjustment. More descriptions of the count of adjustments to the step size may be found in the following related description.

In some embodiments, the processing device may use a step size determination model to process a reference image frame to obtain the step size. For example, the processing device may input the reference image frames into the step size determination model, and the step size determination model outputs the step size. The step size determination model may be a machine learning model such as a Graph Neural Network (GNN) model, a Convolutional Neural Networks (CNN) model, or the like. The processing device may train the step size determination model using a historical reference image frames as training data, enabling the model to output the corresponding step size based on the reference image frame. A label corresponding to the training data may be determined by manual input or historical data.

In some embodiments, the processing device may determine the step size based on a distance between a target subject and the video acquisition device when the video acquisition device acquires the reference image frame or when the flashlight flashes. In some embodiments, the step size may be proportional to the distance between the target subject and the video acquisition device, i.e., the greater the distance between the target subject and the video acquisition device is, the larger the step size may be.

The target subject refers to the subject that triggers an alert or the flashing of the flashlight. For example, the target subject may be a person, an animal, a vehicle, etc., that triggers the alert.

In some embodiments, the processing device may determine the distance between the target subject and the video acquisition device based on data collected by a rangefinder. The rangefinder may include a radar rangefinder, an infrared rangefinder, etc. In some embodiments, the rangefinder may be integrated into the video acquisition device. In some embodiments, the rangefinder may be separate from the video acquisition device.

In some embodiments, the processing device may determine a position of the target subject in the reference image frame and determine the distance between the target subject and the video acquisition device based on the position of the target subject in the reference image frame. For example, the processing device may identify the target subject in the reference image frame by using a target recognition algorithm. By utilizing a coordinate transformation matrix of the video acquisition device, the processing device may convert the position of the target subject in the reference image frame into a spatial coordinate position in a spatial coordinate system, and determine the distance between the video acquisition device and the target subject based on the spatial coordinate position of the target subject and the position of the image acquisition in the spatial coordinate system. Examples of the target recognition algorithm may include a Blob analysis technique, a template matching technique, a deep learning technique, etc.

The time point when the target subject is located at the spatial coordinate position to determine the distance between the target subject and the video acquisition device may be the time point when the target subject enters a monitoring region of the video acquisition device and triggers the alert, i.e., the time point at which the flashlight flashes. The reference image frame refers to the image frame collected by the video acquisition device at the aforementioned time point. In some embodiments, the reference image frame may be the image frame acquired by the video acquisition device before the flashlight flashes. For example, the reference image frame may be the first image frame. As another example, the reference image frame may be an image frame adjacent to the first image frame.

It may be understood that if the target subject is relatively close to the video acquisition device, a reflection of the target subject may interfere with the video acquisition device determination of whether the target subject has entered the monitoring region, causing the flash to continue, or the flash to be repeatedly triggered due to the target subject moving back and forth at a boundary of the monitoring region, leading to repeated changes in image brightness. Therefore, to reduce repetitive fluctuations in image brightness and improve the video quality after adjusting the exposure parameter lower limit, the exposure parameter lower limit may be gradually adjusted through the step size, thereby gradually adjusting the exposure parameter of the video acquisition device from the second exposure parameter to the target exposure parameter, making the change in image brightness smoother. In addition, since the distance between the target subject and the video acquisition device may indicate a degree of interference of the target subject to video acquisition of the video acquisition device, the step size may be determined based on the degree of interference. The smaller the distance between the target subject and the video acquisition device, the higher the reflectivity level of the target subject, and the more easily the video acquisition device is interfered with by the target subject. Therefore, a smaller step size may be set to adjust the exposure parameter lower limit, which results in a larger count of adjustments to the exposure parameter lower limit, thereby smoothing the change in image brightness. Conversely, the larger the distance between the target subject and the video acquisition device, the lower the reflectivity level of the target subject, and the less likely the video acquisition device may be interfered with by the target subject. Therefore, a larger step size may be set to adjust the exposure parameter lower limit, which results in a smaller count of adjustments to the exposure parameter lower limit, thereby improving the efficiency of exposure recovery.

In some embodiments, the processing device may compile the distance between the target subject and the video acquisition device and the step size obtained based on experience into a data lookup table, and determine the step size based on the data lookup table.

In some embodiments, the processing device may determine the reflectivity level of the target subject in the reference image frame and determine the step size based on the reflectivity level. In some embodiments, the step size may be inversely proportional to the reflectivity level of the target subject. In other words, the higher the reflectivity level of the target subject is, the smaller the step size may be.

The reflectivity level refers to a difference in brightness between an image portion corresponding to the target subject in a monitoring image collected by the video acquisition device and other image portions in the monitoring image. The reflectivity level of the target subject in the monitoring image may reflect, to some extent, the distance between the target subject and the video acquisition device. In other words, the higher the reflectivity level of the target subject in the monitoring image, the closer the target subject is to the video acquisition device; conversely, the lower the reflectivity level of the target subject in the monitoring image, the farther the target subject is from the video acquisition device.

In some embodiments, the processing device may determine the reflectivity level of the target subject based on pixel information of a region in the reference image frame corresponding to the target subject and/or pixel information of the reference image frame.

In some embodiments, the processing device may determine a target region in the reference image frame that corresponds to the target subject, and then determine the reflectivity level of the target subject in the reference image frame based on the pixel information in the target region and the pixel information of the reference image frame.

The pixel information refers to information related to pixels in the reference image frame. In some embodiments, the pixel information may include pixel values, brightness values, grayscale values of the pixels in the reference image frame, etc.

The pixel information of the target region corresponding to the target subject in the reference image frame refers to information related to pixels located within the target region corresponding to the target subject in the reference image frame.

In some embodiments, the processing device may use a target recognition algorithm to identify the target subject in the reference image frame, thereby determining the target region in the reference image frame corresponding to the target subject. In some embodiments, the target region may be defined by the boundary of the target subject. In other words, the boundary of the target region may be the same as the boundary of the target subject. In some embodiments, the target region may be defined by a regular box (e.g., a minimum box) that encompassing the target subject. The processing device may determine the reflectivity level of the target subject based on the pixel information of the target region in the reference image frame corresponding to the target subject and the pixel information of the reference image frame. Examples of the target recognition algorithm may include a Blob analysis technique, a template matching technique, a deep learning technique, etc.

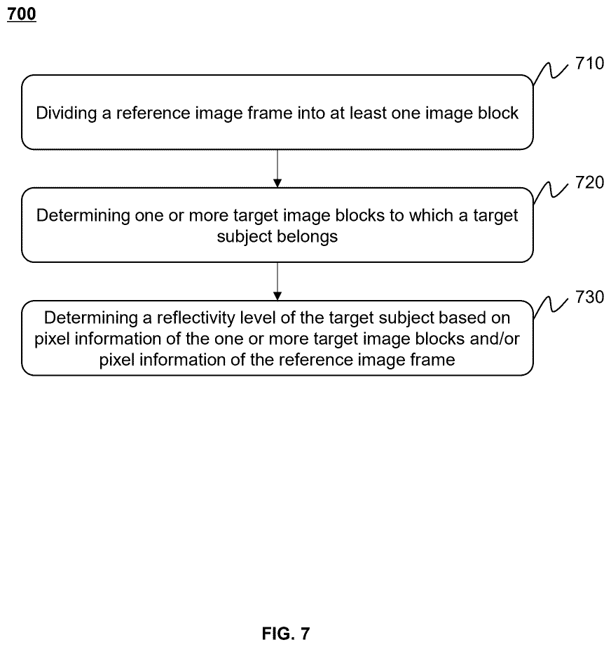

In some embodiments, the processing device may divide the reference image frame into at least one image block and determine one or more target image blocks to which the target subject belongs. The one or more target image blocks may constitute of the target region. In other words, the target region may encompass the boundary of the target subject. Then, the processing device may determine, based on pixel information of the target image block and/or the pixel information of the reference image frame, the reflectivity level of the target subject. More descriptions on determining the reflectivity level of the target subject may be found in FIG. 7 and the related descriptions thereof.

In some embodiments, the processing device may obtain an initial step size and obtain the step size by adjusting the initial step size accordingly based on the reflectivity level.

The initial step size may be a predefined step size. In some embodiments, if the target subject does not strongly interfere with the video acquisition device, the exposure parameter lower limit may be adjusted based on the initial step size. The target subject does not strongly interfere with the video acquisition device means that no target subject exists in the reference image frame. For example, a person naturally enters and exits the reference image frame, and by the time the flashing ends, the target subject (e.g., the person) may be no longer in the reference image frame. Conversely, if the target subject is still in the reference image frame at the end of the flashing, the target subject (e.g., the person) may be considered to strongly interfere with the video acquisition device.

It may be understood that the higher the reflectivity level of the target subject, the closer the target subject is to the video acquisition device, and the more easily the video acquisition device is interfered by the target subject. In this case, the step size may be reduced to increase the count of adjustments to the exposure parameter lower limit, thereby smoothing the changes in image brightness. Conversely, the lower the reflectivity level of the target subject, the farther the target subject is from the video acquisition device. In this case, the step size may be increased to reduce the count of adjustments to the exposure parameter lower limit, thereby improving the efficiency of exposure recovery. In other words, there is a negative correlation between the reflectivity level and the step size: the higher the reflectivity level of the target image is, the smaller the step size may be; the lower the reflectivity level of the target image is, the larger the step size may be.

The greater the reflectivity level is, the stronger the interference of the target subject with the video acquisition device may be. Therefore, the video acquisition device is easily interfered by the target subject and repeatedly triggers the flashlight to flash. For example, the target subject repeatedly triggers the alert of the video acquisition device when the target subject is located at the boundary of the monitoring region. Therefore, when adjusting the exposure parameter lower limit based on the step size, considering the interference of the target subject with the video acquisition device, the initial step size may be adjusted, which is equivalent to changing the adjustment speed of the exposure parameter lower limit and weakening the interference of the target subject. For example, the processing device may adjust the initial step size based on Equation (2) to obtain the step size.

$$step = {step}_{0} \times ( 1 - ref ) , \qquad ( 2 )$$

where step denotes the step size, step₀ denotes the initial step size, and ref denotes the reflectivity level. According to Equation (6) and Equation (8), ref is a decimal between 0 and 1.

In some embodiments, the processing device may determine an amplitude of step size adjustment based on the obtained reflectivity level of the target subject, and adjust the initial step size based on the amplitude of step size adjustment to obtain the step size.

The amplitude of step size adjustment refers to a magnitude of an adjustment to the initial step size. For example, the amplitude of step size adjustment may be 1−ref in Equation (2). It may be understood that based on the reflectivity level of the target subject, the initial step size is adjusted accordingly, which determines the amplitude of step size adjustment for adjusting the initial step size, thereby adjusting the initial step size accordingly. The higher the reflectivity level of the target subject is, the smaller the amplitude of step size adjustment is, making the adjustment amount of the initial step size smaller; conversely, the lower the reflectivity level of the target subject is, the larger the amplitude of step size adjustment is, making the adjustment amount of the initial step size larger. In other words, there is a negative correlation between the amplitude of step size adjustment and the reflectivity level of the target subject.

In some embodiments of the present disclosure, adjusting the step size based on the reflectivity level of the target subject reduces the interference caused by the target subject during the adjustment of the exposure parameter lower limit, thereby improving the image quality of the adjusted target exposure parameter corresponding to the image.

In some embodiments, the processing device may incrementally increase the exposure parameter lower limit multiple times based on the step size until the termination condition is satisfied. More descriptions on the multiple increases of the exposure parameter lower limit and the termination condition may be found in the preceding related descriptions.

For example, the processing device may uniformly adjust the exposure parameter lower limit of the video acquisition device based on the step size according to Equation (3), so that the exposure parameter of the video acquisition device is adjusted from the second exposure parameter to the target exposure parameter.

$$shutterCur = {shutter}_{min} + m \times step , \qquad ( 3 )$$

where shutterCur denotes the adjusted exposure parameter lower limit (i.e., the target exposure parameter), shutterₘᵢₙ denotes the exposure parameter lower limit, m denotes the count of adjustments to the exposure parameter lower limit, and step denotes the step size. If the target subject does not strongly interfere with the video acquisition device, the step size may be the initial step size step₀; if the target subject strongly interferes with the video acquisition device, the step size may be obtained through equation (2). More descriptions on whether the target subject strongly interferes with the video acquisition device may be found in the preceding related descriptions.

In some embodiments of the present disclosure, adjusting the exposure parameter lower limit based on the step size can reduce the repetitive fluctuation of image brightness, making the change in image brightness smoother, thereby improving the video quality of the image after adjusting the exposure parameter lower limit.

In 440, the video acquisition device may be caused to acquire a target image frame based on the target exposure parameter. Operation 440 may be executed by the processing device 120 or the collection module 340.

The target image frame refers to an image frame acquired by the video acquisition device based on the target exposure parameter after the adjustment of the exposure parameter lower limit of the video acquisition device has ended. More descriptions of the video acquisition device may be found in FIG. 1 and the related descriptions thereof.

In some embodiments, a difference between a brightness of the target image frame and a brightness of the first image frame may be less than a brightness threshold. It may be understood that since the target exposure parameter matches the first exposure parameter, the difference between the target exposure parameter and the first exposure parameter may be less than the difference threshold. Therefore, correspondingly, the difference between the brightness of the target image frame collected by the video acquisition device based on the target exposure parameter and the brightness of the first image frame collected by the video acquisition device based on the first exposure parameter is less than the brightness threshold. The brightness threshold and the difference threshold has a corresponding relationship, and once the difference threshold is determined, the brightness threshold may be determined accordingly. More descriptions of the difference threshold may be found in the preceding related descriptions.

In some embodiments, the processing device may control the video acquisition device to collect the target image frame based on the target exposure parameter.

In some embodiments of the present disclosure, by adjusting the exposure parameter lower limit of the video acquisition device from the second exposure parameter to the target exposure parameter matching the first exposure parameter, the video acquisition device can collect the target image frame, enabling the brightness of the image collected by the video acquisition device after the flashing of the flashlight to be restored to the brightness of the image collected by the video acquisition device before the flashing of the flashlight, thus achieving exposure recovery.

In some embodiments, the processing device may reduce the exposure parameter according to a method that is the same as or similar to the process 400. For example, the processing device may reduce the exposure parameter lower limit to reduce the exposure parameter when the second exposure parameter exceeds the first exposure parameter.

It should be noted that the above descriptions of the process 400 is merely provided for the purposes of illustration, and are not intended to limit the scope of the present disclosure. For persons having ordinary skills in the art, multiple variations or modifications may be made under the teachings of the present disclosure. However, those variations and modifications do not depart from the scope of the present disclosure.

In some embodiments, before performing operations 410 to 430, the processing device may determine whether the exposure time of the video acquisition device is sacrificed by determining whether the first exposure parameter exceeds a threshold. In response to determining that the first exposure parameter exceeds the threshold, the processing device may execute operations 410 to 430 to determine the target exposure parameter. In response to determining that the first exposure parameter does not exceed the threshold, the processing device does not need to execute operations 410 to 430. The target exposure parameter may be determined based on a defaulting set of the system 100, such as the AE algorithm.

In some embodiments, the processing device may determine the threshold by subtracting a flashing duration of the flashlight from a reference exposure time (e.g., the exposure time upper limit) of the video acquisition device. For example, as shown in FIG. 5, the threshold in the drawing is obtained by subtracting the flashing duration from the exposure time per frame (i.e., an exposure interval time plus a duration of an exposure region). When the first exposure time is less than the threshold, there is enough time for the flashing of the flashlight, and there will be no flashing phenomenon of the flashlight in the image. Therefore, it may not be necessary to reduce the first exposure time during the flashing process of the flashlight to determine the second exposure time used to acquire the current image frame. The second exposure time may be the same as the first exposure time. Conversely, as shown in FIG. 5, when the first exposure time is greater than the threshold (i.e., the duration of the exposure region of the first exposure time is greater than the threshold), there is not enough time for the flash action of the flashlight. Therefore, it may be necessary to reduce the first exposure time (i.e., reduce the first exposure time to the second exposure time) during the flashing process of the flashlight to avoid the flashing phenomenon of the flashlight in the image, thus the method for video acquisition may be needed.

In some embodiments of the present disclosure, by determining whether the first exposure parameter is greater than the threshold to determine whether to perform the method for video acquisition, only the exposure parameter that requires the method for video acquisition is restored, thereby improving the efficiency of exposure adaptive recovery.

FIG. 7 is a flowchart illustrating an exemplary process for determining a reflectivity level of a target subject according to some embodiments of the present disclosure. In some embodiments, process 700 may be executed by the system 100 for video acquisition. For example, the process 700 may be implemented as a set of instructions stored in a storage device. In some embodiments, the processing device 120 (e.g., the processor 210 of the computing device 200 and/or one or more modules illustrated in FIG. 3) may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting. In some embodiments, the process 700 may be executed by the processing device 120 or the adjustment module 330.

In 710, a reference image frame may be divided into at least one image block.

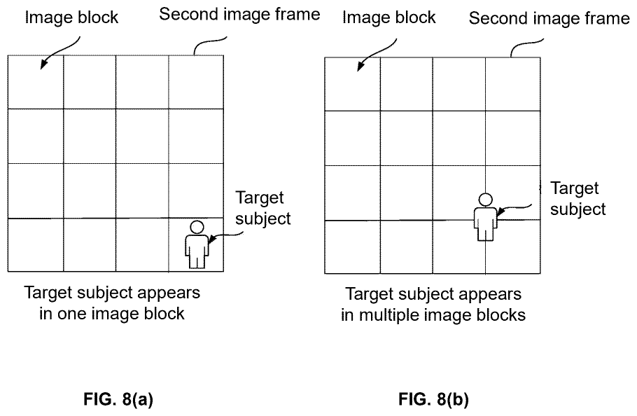

An image block refers to a region in the reference image frame formed by dividing the reference image frame. As shown in FIGS. 8(a) and 8(b), the reference image frame is divided into 16 image blocks.

In some embodiments, the processing device may divide a monitoring image into a plurality of blocks based on a block threshold. The block threshold refers to a count of the image blocks. For example, the processing device may evenly divide the reference image frame into the count of image blocks specified by the block threshold.

By dividing the reference image frame into at least one image block, it is possible to analyze and process the reference image frame block by block, reducing the complexity of the data processing process, and analyzing image blocks improves the accuracy of data processing compared to analyzing the entire reference image frame.

In 720, one or more target image blocks to which a target subject belongs may be determined.

A target image block refers to the image block where the target subject is located. In some embodiments, the count of target image blocks may be one or more. For example, as shown FIG. 8(a), if the target subject appears only in one image block, then the image block in which the target subject appears is the target image block. As another example, as shown in FIG. 8(b), if the target subject appears in multiple image blocks, then the multiple image blocks in which the target subject appears are the target image blocks.

In some embodiments, the processing device may identify the target subject in the reference image frame through a target recognition algorithm, etc., to determine the one or more image blocks where the target subject is located from the at least one image block, thereby determining the one or more target image blocks. More descriptions of the target recognition algorithm may be found in FIG. 4 and the related descriptions thereof.

In 730, a reflectivity level of the target subject may be determined based on pixel information of the one or more target image blocks and/or pixel information of the reference image frame.

The pixel information of the one or more target image blocks refers to information related to pixels of the one or more target image blocks. More descriptions of the pixel information may be found in FIG. 4 and the related descriptions thereof.

Considering that numerical values of brightness for different types of images are different, reflectivity levels of target subjects in different types of images may be determined in different ways. The types of images in monitoring may include a color image and, a black-and-white image, so the reflectivity levels of the target subjects in a color image and a black-and-white image may be determined in different ways.

In some embodiments, the processing device may determine whether the reference image frame is a color image or a black-and-white image. In response to determining that the reference image frame is a color image, the processing device may determine the reflectivity level of the target subject based on the color image; in response to determining that that the reference image frame is a black-and-white image, the processing device may determine the reflectivity level of the target subject based on the black-and-white image.

In some embodiments, in response to determining that the reference image frame is a color image, the processing device may determine a brightness variance of the one or more target image blocks based on the pixel information of the one or more target image blocks. The processing device may determine the reflectivity level of the target subject based on the brightness variance of the one or more target image blocks.

For example, in response to determining that the reference image frame is a color image, the pixel information of the reference image frame may be the brightness value of each pixel in the reference image frame. The processing device may determine the brightness variance of the one or more target image blocks according to equation (4) as following:

$$S = \frac{{\sum }_{i}^{n} {( {y}_{i} - \overline{y} )}^{2}}{n} \qquad ( 4 )$$

Where, S denotes the brightness variance of the one or more target image blocks, yᵢ denotes the brightness value of an i-th target image block in the reference image frame, which may be obtained by summing the brightness values of all pixels in the i-th target image block, y̅ denotes an average brightness value of the reference image frame, which may be obtained by determining an average of the brightness values of all pixels in the reference image frame, n denotes the count of one or more target image blocks, with the maximum value being the total count of image blocks. For example, in FIG. 8(a), n=1, and in FIG. 8(b), n=4.

The processing device may determine a dynamic range level of the one or more target image blocks according to Equation (5), i.e., the processing device may normalize the brightness variance of the one or more target image blocks according to Equation (5):

$$level = \frac{{S}_{max} - S}{{S}_{max} - {S}_{min}} \times ( {level}_{max} - {level}_{min} ) , \qquad ( 5 )$$

wherein, level denotes the dynamic range level of the one or more target image blocks, S denotes the brightness variance of the one or more target image blocks, levelₘₐₓ denotes an upper limit of the dynamic range level, levelₘᵢₙ denotes a lower limit of the dynamic range level (e.g., levelₘᵢₙ may be 0), Smax denotes a brightness variance corresponding to a minimum exposure parameter (i.e., the exposure parameter lower limit) in a bright environment, and Sₘᵢₙ denotes a brightness variance corresponding to a maximum exposure parameter (i.e., the exposure parameter upper limit) in a dark environment (e.g., Sₘᵢₙ may be 0).

The processing device may determine a ratio of the dynamic range level of the one or more target image blocks to the upper limit of the dynamic range level as the reflectivity level of the target subject, i.e., the processing device may determine the reflectivity level of the target subject according to Equation (6):

$$ref = \frac{level}{{level}_{max}} , \qquad ( 6 )$$

where, ref denotes the reflectivity level of the target subject, level denotes the dynamic range level of the one or more target image blocks, levelₘₐₓ denotes the upper limit of the dynamic range level.

In some embodiments, in response to determining that the reference image frame is a black-and-white image, the processing device may determine a similarity level between the pixel information of each of the one or more target image blocks and the pixel information of the reference image frame under a pure infrared light source, and determine, based on a count of image blocks in the one or more target image blocks that satisfy a similarity condition and a total count of the one or more target image blocks, the reflectivity level of the target subject.

For example, in response to determining that the reference image frame is a black-and-white image, the pixel information of the reference image frame may be a color excitation value of each pixel in the reference image frame. For example, the color excitation value may include a red excitation value (i.e., Rgain value), a blue excitation value (i.e., Bgain value), etc.

The processing device may determine the similarity level between pixel information of each of the one or more target image blocks and pixel information of the reference image frame under a pure infrared light source according to Equation (7) as followings:

$${Dist}_{i} = \sqrt{{( {Rgain}_{i} - irRgain )}^{2} + {( {Bgain}_{i} - irBgain )}^{2}} , \qquad ( 7 )$$

where Distᵢ denotes the similarity level between the pixel information of an i-th image block in the one or more target image blocks and the pixel information of the reference image frame acquired under the pure infrared light source, Rgain; denotes the Rgain value of the i-th image block, Bgain; denotes the Bgain value of the i-h image block, irRgain and irBgain denote the Rgain value of the reference image frame under only the infrared light source and the Bgain value of the reference image frame under only the infrared light source, respectively. The Rgain value may be an average value of the Rgain values of all pixels in the reference image frame or a statistic value, i.e., a sum of the Rgain values of all pixels in the reference image frame, and if Rgainᵢ is an average value, irRgain is an average value correspondingly; if Rgainᵢ is a statistic value, irRgain is a statistic value correspondingly. The Bgain value may be an average value of the Bgain values of all pixels in the reference image frame or a statistic value, i.e., a sum of the Bgain values of all pixels in the reference image frame, and if Bgainᵢ is an average value, irBgain is an average value correspondingly; if Bgainᵢ is a statistic value, irBgain is a statistic value correspondingly.

Subsequently, the processing device may determine whether a reflection situation exists by determining whether the similarity level between the pixel information of the i-th image block in the one or more target image blocks and the pixel information under the pure infrared light source satisfies the similarity condition. The similarity condition may include the similarity level being greater than a similarity threshold Distᵢᵣ, which may be determined based on historical experience. If the similarity level is greater than the similarity threshold Distᵢᵣ, it may be determined that the reflection situation exists; otherwise, it may be determined that the reflection situation does not exist. In some embodiments, the similarity level may be obtained through other techniques of distance determination, such as a cosine distance, a Mahalanobis distance, a Chebyshev distance, a Manhattan distance, etc. Correspondingly, the distance threshold may be a cosine distance threshold, a Mahalanobis distance threshold, a Chebyshev distance threshold, a Manhattan distance threshold, etc.

The processing device determines the count of blocks in the one or more target image blocks that satisfy the similarity condition by determining whether the similarity level between the pixel information of each image block and the pixel information of the reference image frame under the pure infrared light source is greater than the similarity threshold Distᵢᵣ. Then, the processing device may determine the reflectivity level of the target subject according to Equation (8).

$$ref = \frac{{irA}_{n u m}}{{A}_{n u m}} , \qquad ( 8 )$$

where ref denotes the reflectivity level of the target subject, irAₙᵤₘ denotes the count of blocks in the one or more target image blocks that satisfy the similarity condition, and Aₙᵤₘ denotes the total count of the one or more target image blocks.

In some embodiments of the present disclosure, by determining the reflectivity level for different types of reference image frames in different ways, the everyday usage needs of the video acquisition device are covered, and the versatility of the method for video acquisition in the present disclosure is enhanced.

It should be noted that the above description of the process 400 is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

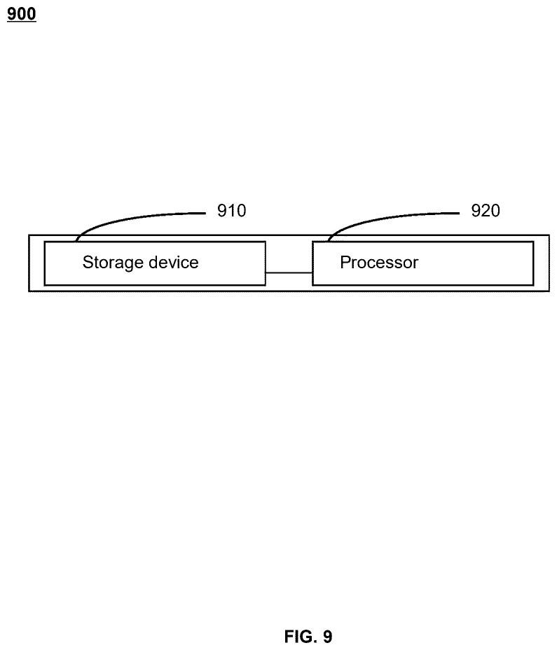

FIG. 9 is a schematic diagram illustrating an exemplary electronic device according to some embodiments of the present disclosure. An electronic device 900 may include a storage device 910 and at least one processor 920. The at least one processor 920 may execute one or more program instructions stored in the storage device 910 to implement the operations of the method for video acquisition described in any of the embodiments above. In a specific implementation scenario, the electronic device 900 may include but is not limited to: a microcomputer, a server, a laptop, a tablet, and other mobile devices, which is not limited by the present disclosure.

Specifically, the at least one processor 920 may control itself and the storage device 910 to implement the operations the method for video acquisition described in any of the embodiments above. The at least one processor 920 may also be referred to as a central processing unit (CPU). The at least one processor 920 may be an integrated circuit chip with signal processing capabilities. The at least one processor 920 may be a general-purpose processor, a digital signal processor (DSP), an application-specific integrated circuit (ASIC), a field-programmable gate array (FPGA), or other programmable logic devices, discrete gates, or transistor logic devices, discrete hardware components. The general-purpose processor may be a microprocessor or any other conventional processor, etc. Additionally, the at least one processor 920 may be implemented by a combination of integrated circuit chips.

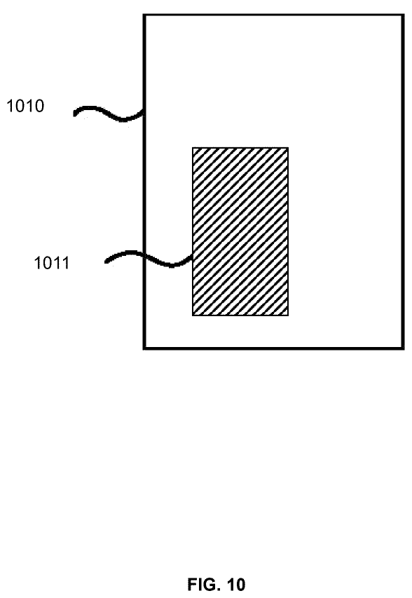

FIG. 10 is a schematic diagram illustrating an exemplary non-transitory computer-readable storage medium according to some embodiments of the present disclosure. A non-transitory computer-readable storage medium 1010 may be configured to store one or more program instructions 1011 that may be executed by at least one processor to implement the operations of the method for video acquisition described in any of the embodiments above.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure; For example, the terms “one embodiment,” “an embodiment,” and/or “some embodiments” mean that a particular feature, structure, or characteristic described in connection with the embodiment is included in at least one embodiment of the present disclosure; Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure;

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method implemented by a computing device including at least one processor and a storage device for video acquisition, comprising:
obtaining a first exposure parameter of a video acquisition device when the video acquisition device acquires a first image frame;
obtaining a second exposure parameter used by the video acquisition device to acquire a second image frame, wherein the second exposure parameter is smaller than the first exposure parameter;
adjusting an exposure parameter of the video acquisition device from the second exposure parameter to a target exposure parameter by adjusting an exposure parameter lower limit of the video acquisition device, wherein the target exposure parameter matches the first exposure parameter; and
causing, based on the target exposure parameter, the video acquisition device to acquire a target image frame.

2. The method of claim 1, wherein the adjusting an exposure parameter of the video acquisition device from the second exposure parameter to a target exposure parameter by adjusting an exposure parameter lower limit of the video acquisition device includes:
obtaining a step size for adjusting the exposure parameter lower limit of the video acquisition device; and
adjusting the exposure parameter lower limit based on the step size.

3. The method of claim 2, wherein the obtaining the step size for adjusting the exposure parameter lower limit of the video acquisition device includes:
determining the step size based on a distance between a target subject entering into a monitoring region of the video acquisition device and the video acquisition device.

4. The method of claim 2, wherein the obtaining the step size for adjusting the exposure parameter lower limit of the video acquisition device includes:
determining, based on a reference image frame, a reflectivity level of a target subject entering into a monitoring region of the video acquisition device; and
determining the step size based on the reflectivity level.

5. The method of claim 4, wherein the determining, based on a reference image frame, a reflectivity level of a target subject entering into a monitoring region of the video acquisition device includes:
determining the reflectivity level of the target subject based on pixel information of a region in the reference image frame corresponding to the target subject and/or pixel information of the reference image frame.

6. The method of claim 5, wherein the determining the reflectivity level of the target subject based on pixel information of a region in the reference image frame corresponding to the target subject and/or pixel information of the reference image frame includes:
dividing the reference image frame into at least one image block;
determining one or more target image blocks to which the target subject belongs, wherein the one or more target image blocks corresponds to the region in the reference image frame corresponding to the target subject; and
determining the reflectivity level of the target subject based on pixel information of the one or more target image blocks and/or the pixel information of the reference image frame.

7. The method of claim 6, wherein the determining the reflectivity level of the target subject based on pixel information of the one or more target image blocks and/or the pixel information of the reference image frame includes:
in response to determining that the reference image frame is a color image,
determining a brightness variance of the one or more target image blocks based on the pixel information of the one or more target image blocks and the pixel information of the reference image frame; and
determining the reflectivity level of the target subject based on the brightness variance of the one or more target image blocks.

8. The method of claim 6, wherein the determining the reflectivity level of the target subject based on pixel information of the one or more target image blocks and/or the pixel information of the reference image frame includes:
in response to determining that the reference image frame is a black and white image,
determining a similarity level between pixel information of each of the one or more target image blocks and pixel information of the reference image frame under a pure infrared light source; and
determining, based on a count of image blocks in the one or more target image blocks that satisfy a similarity condition and a count of the one or more target image blocks, the reflectivity level of the target subject.

9. The method of claim 1, wherein the adjusting an exposure parameter of the video acquisition device from the second exposure parameter to a target exposure parameter by adjusting an exposure parameter lower limit of the video acquisition device includes:
adjusting the exposure parameter of the video acquisition device from the second exposure parameter to the target exposure parameter by iteratively increasing the exposure parameter lower limit until a termination condition is satisfied, after each increase in the exposure parameter lower limit, an intermediate exposure parameter lower limit, an intermediate exposure parameter, and an intermediate image frame being determined, wherein the termination condition includes the intermediate exposure parameter being equal to the first exposure parameter, or a brightness of the intermediate image frame being equal to a brightness of the first image frame.

10. The method of claim 9, wherein the second exposure parameter is greater than the exposure parameter lower limit, and the increase of the exposure parameter lower limit includes a first stage and a second stage;
in the first stage, the intermediate exposure parameter lower limit is less than or equal to the second exposure parameter; and
in the second stage, the intermediate exposure parameter lower limit is greater than the second exposure parameter, and a difference between two adjacent intermediate exposure parameter lower limits in the first stage is greater than a difference between two adjacent intermediate exposure parameter lower limits in the second stage.

11. The method of claim 1, wherein the adjusting an exposure parameter of the video acquisition device from the second exposure parameter to a target exposure parameter by adjusting an exposure parameter lower limit of the video acquisition device includes:
adjusting the exposure parameter of the video acquisition device from the second exposure parameter to the target exposure parameter by iteratively increasing the exposure parameter lower limit until a termination condition is satisfied, an intermediate exposure parameter lower limit and an intermediate exposure parameter being determined after each increase in the exposure parameter lower limit;
wherein the method further comprises:
after each increase in the exposure parameter lower limit, obtaining an intermediate image frame acquired by the video acquisition device based on the intermediate exposure parameter;
determining whether a brightness of the intermediate image frame is greater than a target brightness of the video acquisition device;
in response to determining that the brightness of the intermediate image frame is greater than the target brightness, reducing a brightness gain of the video acquisition device so that the brightness of the intermediate image frame is not greater than the target brightness.

12. The method of claim 11, wherein the termination condition includes the brightness gain of the video acquisition device being equal to 0 dB.

13. The method of claim 1, further comprising:
determining whether the first exposure parameter is greater than a threshold; and
in response to determining that the first exposure parameter is greater than the threshold, executing a method comprising:
obtaining the second exposure parameter used by the video acquisition device to acquire the second image frame, wherein the second exposure parameter is smaller than the first exposure parameter;
adjusting the exposure parameter of the video acquisition device from the second exposure parameter to the target exposure parameter by adjusting the exposure parameter lower limit of the video acquisition device, wherein the target exposure parameter matches the first exposure parameter; and
causing, based on the target exposure parameter, the video acquisition device to acquire the target image frame.

14. The method of claim 1, wherein a difference between a brightness of the target image frame and a brightness of the first image frame is less than a brightness threshold.

15. (canceled)

16. A device for video acquisition, comprising a processor, wherein the processor executes a recognition program, and the recognition program, when executed, performs the method for video acquisition, wherein the method includes:
obtaining a first exposure parameter of a video acquisition device when the video acquisition device acquires a first image frame;
obtaining a second exposure parameter used by the video acquisition device to acquire a second image frame, wherein the second exposure parameter is smaller than the first exposure parameter;
adjusting an exposure parameter of the video acquisition device from the second exposure parameter to a target exposure parameter by adjusting an exposure parameter lower limit of the video acquisition device, wherein the target exposure parameter matches the first exposure parameter; and
causing, based on the target exposure parameter, the video acquisition device to acquire a target image frame.

17. A non-transitory computer-readable storage medium storing one or more computer instructions, wherein when a computer reads the one or more computer instructions from the storage medium, the computer executes the method for video acquisition, wherein the method includes:
obtaining a first exposure parameter of a video acquisition device when the video acquisition device acquires a first image frame;
obtaining a second exposure parameter used by the video acquisition device to acquire a second image frame, wherein the second exposure parameter is smaller than the first exposure parameter;
adjusting an exposure parameter of the video acquisition device from the second exposure parameter to a target exposure parameter by adjusting an exposure parameter lower limit of the video acquisition device, wherein the target exposure parameter matches the first exposure parameter; and
causing, based on the target exposure parameter, the video acquisition device to acquire a target image frame.

18. The method of claim 1, wherein the first exposure parameter and the second exposure parameter are values of the exposure parameter of the video acquisition device at different time periods.

19. The method of claim 2, wherein the step size refers to the amount of adjustment for each adjustment of the exposure parameter lower limit.

20. The method of claim 3, wherein the distance between the target subject entering into the monitoring region of the video acquisition device and the video acquisition device is directly proportional to the step size.

21. The method of claim 4, wherein the determining the step size based on the reflectivity level includes:
obtain an initial step size; and
determining the step size by adjusting the initial step size accordingly based on the reflectivity level.
